(19) United States
(12) Patent Application Publication
(10) Pub. No.: US 2026/0001248 A1
(43) Pub. Date: Jan. 1, 2026

(54) RAZOR

(71) Applicant: KAI R&D CENTER CO., LTD., Seki-shi (JP)

(72) Inventors: Keita NAKADA, Seki-shi (JP); Jun OTSUKA, Seki-shi (JP)

(73) Assignee: KAI R&D CENTER CO., LTD., Seki-shi (JP)

(21) Appl. No.: 19/318,719

(22) Filed: Sep. 4, 2025

Related U.S. Application Data
(63) Continuation of application No. PCT/JP2023/013248, filed on Mar. 30, 2023.

(51) Int. Cl. B26B 21/56; B26B 21/52

(52) U.S. Cl. CPC B26B 21/565; B26B 21/522

(57) ABSTRACT

A razor (1) according to the present disclosure includes: a head part (10) to which a blade body (11) is attached; a handle part (20); a placement surface (L1) that comes into contact with a predetermined plane (P) when the razor (1) is placed on the predetermined plane (P); and a central surface (L2) passing along the placement surface (L1) and passing through a center of the handle part (20) in a thickness direction (T), wherein a blade edge (11A) of the blade body (11) is directed toward an upper side (U) from the central surface (L2) toward the placement surface (L1), when the razor (1) with the head part (10) disposed on the upper side (U) is viewed from a side surface thereof, and the blade body (11) is curved so as to convex toward the upper side (U), when the razor (1) with the head part (10) disposed on the upper side (U) is viewed from the back surface side.

### CROSS-REFERENCE TO RELATED APPLICATIONS

The present application is a continuation of PCT Application No. PCT/JP2023/013248, filed on Mar. 30, 2023, the entire contents of each application being incorporated herein by reference in its entirety.

### TECHNICAL FIELD

The present disclosure relates to a razor.

### BACKGROUND

Conventionally, a razor for shaving armpit hair is known (see, for example, JP-U S56-125171).

### SUMMARY OF THE INVENTION

However, the razor disclosed in JP-U S56-125171 has a problem in that, when a head part is brought into contact with the armpit, a plastic portion of the head part, not a blade edge, is more likely to hit the armpit because the blade edge faces downward.

Therefore, the present disclosure has been made in view of the above-described problem, and an object of the present disclosure is to provide a razor making it easy to place a blade edge in an armpit recess.

The first aspect of the present disclosure is summarized as a razor having a vertical direction including an upper side and a lower side and a thickness direction including a front surface side and a back surface side, the razor including: a head part to which a blade body is attached; a handle part; a placement surface that comes into contact with a predetermined plane when the razor is placed on the predetermined plane; and a central surface passing along the placement surface and passing through a center of the handle part in the thickness direction, wherein a blade edge of the blade body is directed toward the upper side from the central surface toward the placement surface, when the razor with the head part disposed on the upper side is viewed from a side surface thereof, and the blade body is curved so as to convex toward the upper side, when the razor with the head part disposed on the upper side is viewed from the back surface side.

According to the present disclosure, it is possible to provide a razor making it easy to place a blade edge in an armpit recess.

### BRIEF DESCRIPTION OF THE DRAWINGS

FIG. 1 is a view illustrating an example of an overall configuration of a razor 1 according to an embodiment.

FIG. 2 is a view illustrating the razor 1 with a head part 10 disposed on an upper side U as viewed from a side surface.

FIGS. 3A and 3B are views of the razor 1 with the head part 10 disposed on the upper side U as viewed from a back surface side S2.

FIG. 4 is a cross-sectional view taken along line A-A′ of FIGS. 3A and 3B.

FIG. 5 is a cross-sectional view taken along line B-B′ of FIGS. 3A and 3B.

FIG. 6 is a view of the razor 1 as viewed from the upper side U.

FIG. 7 is a view for explaining the head part 10 of the razor 1 according to an embodiment.

### DETAILED DESCRIPTION

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

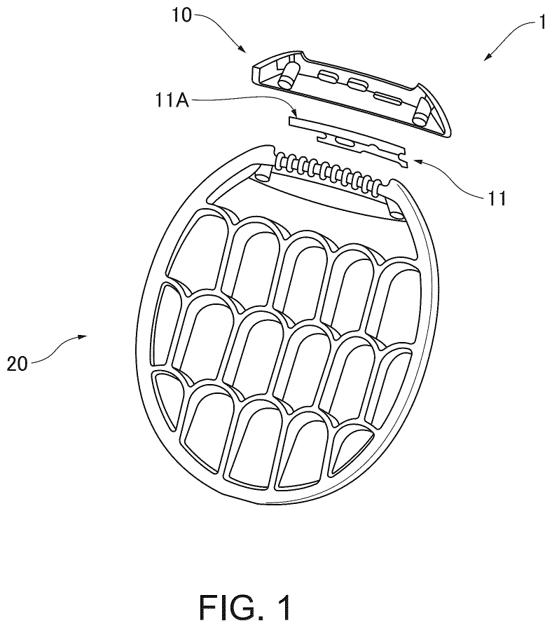

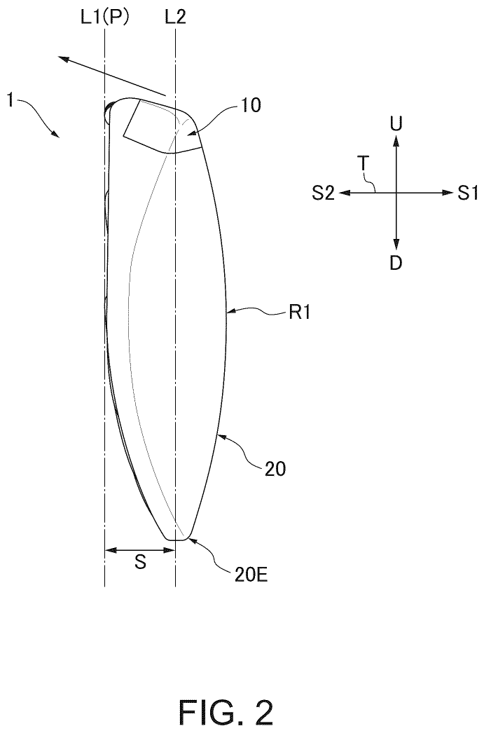

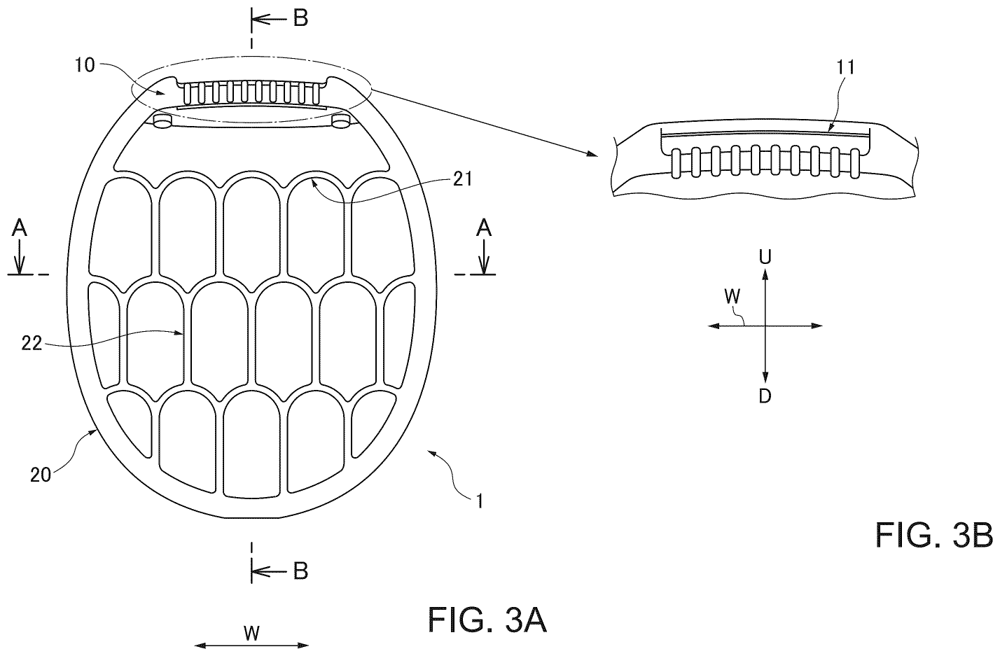

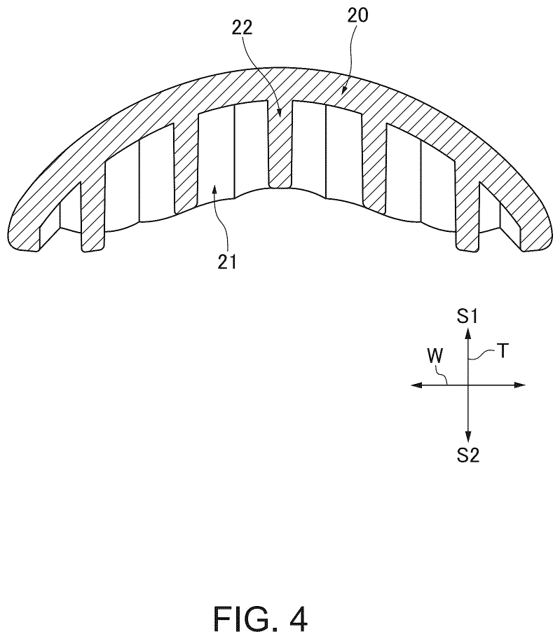

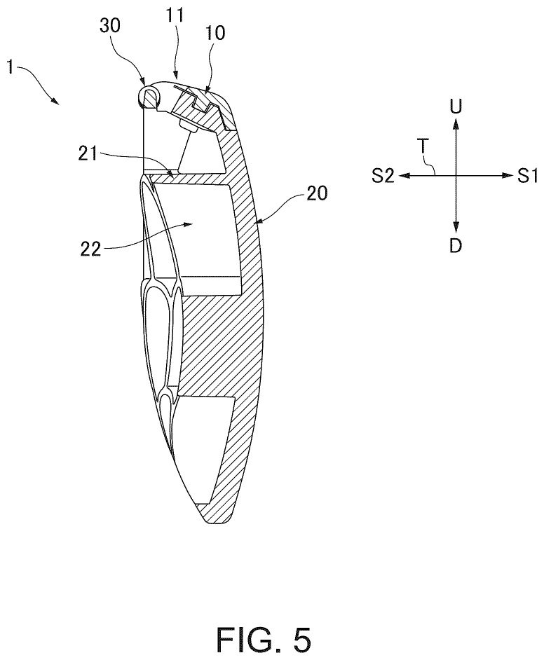

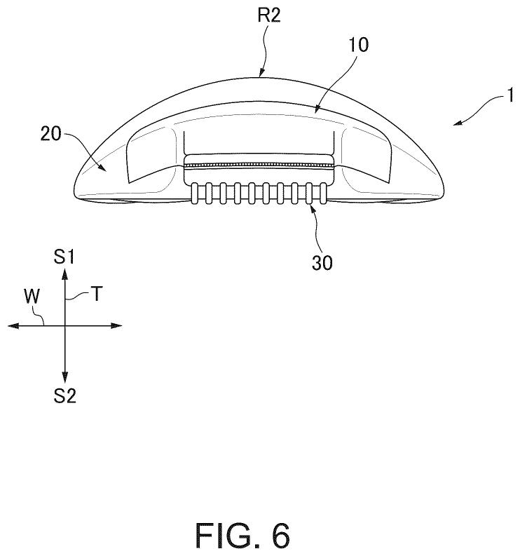

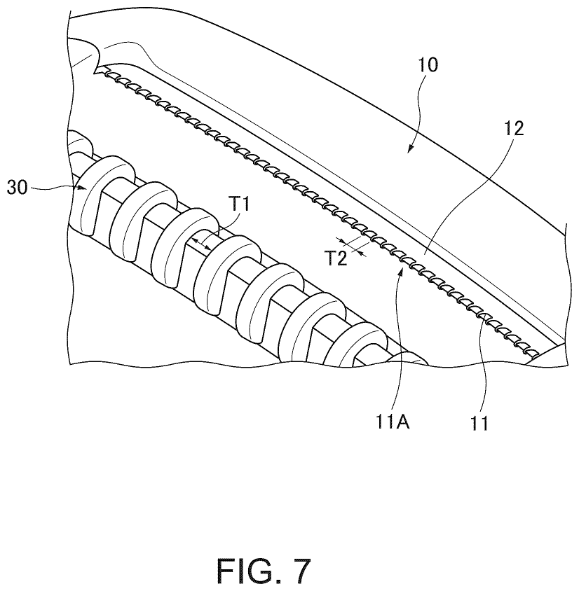

Hereinafter, an embodiment of the present invention will be described with reference to FIGS. 1 to 7. FIG. 1 is a view illustrating an example of an overall configuration of a razor 1 according to an embodiment, FIG. 2 is a view illustrating the razor 1 with a head part 10 disposed on an upper side U as viewed from a side surface, FIGS. 3A and 3B are views of the razor 1 with the head part 10 disposed on the upper side U as viewed from a back surface side S2, FIG. 4 is a cross-sectional view taken along line A-A′ of FIG. 3A, FIG. 5 is a cross-sectional view taken along line B-B′ of FIG. 3A, FIG. 6 is a view of the razor 1 as viewed from the upper side U, and FIG. 7 is a view for explaining the head part 10 of the razor 1 according to an embodiment.

As illustrated in FIG. 1, the razor 1 according to the present embodiment includes a head part 10 to which a blade body 11 is attached, and a handle part 20. As illustrated in FIG. 1, the blade body 11 is sandwiched and held between the head part 10 and the handle part 20.

As illustrated in FIG. 2, the razor 1 has a vertical direction including an upper side U and a lower side D, and a thickness direction T including a front surface side S1 and a back surface side S2.

Further, as illustrated in FIG. 2, the razor 1 has a placement surface L1 that comes into contact with a predetermined plane P when the razor 1 is placed on the predetermined plane P, and a central surface L2 that passes along the placement surface L1 and passes through the center of the handle part 20 in the thickness direction T. The central surface L2 may be parallel to the placement surface L1.

Here, as illustrated in FIGS. 2 and 5, when the razor 1 with the head part 10 disposed on the upper side U is viewed from the side surface, a blade edge 11A of the blade body 11 is configured to be directed toward the upper side (U) from the central surface L2 toward the placement surface L1.

As illustrated in FIGS. 3A and 3B, when the razor 1 with the head part 10 disposed on the upper side U is viewed from the back surface side S2, the blade body 11 is curved so as to convex toward the upper side U.

Normally, when shaving armpit hair, a user applies the razor 1 to the armpit recess from below. Therefore, according to the above-described configuration, since the blade edge 11A is configured to be directed toward the upper side (U) from the central surface L2 toward the placement surface L1, when the user places the razor 1 in the armpit recess from below, the blade edge 11A can easily be applied to the root of the hair. According to such a configuration, since the blade body 11 is curved so as to be convex toward the upper side U, the user can easily fit the blade edge 11A of the blade body 11 to the armpit recess.

As illustrated in FIGS. 6 and 7, the razor 1 may include a plurality of comb teeth members 30. Here, as illustrated in FIG. 6, when the razor 1 is viewed from the upper side U, the plurality of comb teeth members 30 are arranged at first intervals T1 along an extending direction W of the head part 10 on the back surface side S2 of the blade body 11. Here, as illustrated in FIG. 7, each of the plurality of comb teeth members 30 may be formed in an annular shape.

According to such a configuration, curly armpit hair or the like can be combed and tidied up before being shaved, enabling smooth shaving.

As illustrated in FIG. 7, the head part 10 may include a guard portion 12 disposed so as to cover at least a part of the blade edge 11A of the blade body 11.

According to such a configuration, since the guard portion 12 is provided, it is possible to prevent a situation in which the user's skin is damaged when the razor 1 slides sideway.

Here, as illustrated in FIG. 7, the guard portion 12 may be disposed so as to cover the blade edge 11A of the blade body 11 at second intervals T2, and the above-described first intervals T1 may be larger than the second intervals T2. According to such a configuration, the hair can be shaved without damaging the skin.

As illustrated in FIGS. 2, 4, and 5, the handle part 20 may have a shape that is convex on the front surface side S1 and concave on the back surface side S2.

Further, the handle part 20 may have an elliptical shape rather than a rod shape. Specifically, as illustrated in FIGS. 3A and 3B, when the razor 1 is viewed from the front surface side S1 and when the razor 1 is viewed from the back surface side S2, the handle part 20 may be configured to have a width W that increases as being farther away from the head part 10 and decreases after the center of the handle part 20 in the vertical direction.

According to the above-described configuration, it is possible to realize a shape making it easy for the user to hold the handle part when shaving armpit hair.

As illustrated in FIGS. 3A and 3B, the back surface side S2 may be divided by a plurality of curved portions 21 curved so as to be convex toward the upper side U and a plurality of straight portions 22 extending in the vertical direction.

According to such a configuration, fingers placed on the back surface side S2 during use are less likely to slip, making it easy to grip the handle part. In addition, the curved portions 21 convex toward the upper side U enables distinction in the vertical direction by the feel of the fingers without seeing the handle part with the eyes. Therefore, the plurality of straight portions 22 can suppress slippage in the width direction.

Here, as illustrated in FIGS. 3A and 3B, when the razor 1 with the head part 10 disposed on the upper side U is viewed from the back surface side S2, the curved portions 21 and the straight portions 22 may constitute an inverted U-shaped rib. As illustrated in FIGS. 3A and 3B, a plurality of such ribs are arranged at regular cycles in the extending direction W of the head part 10, and a plurality of such ribs are arranged in the vertical direction. As illustrated in FIGS. 3A and 3B, the regular cycles of ribs adjacent in the vertical direction are shifted by a half cycle.

By providing such ribs, the handle part 20 can be made thin, reducing the amount of material used, and the handle part 20 can be made rigid enough to withstand use. Furthermore, it is possible to provide the handle part 20 that can be firmly gripped while suppressing slippage of fingers during use.

As illustrated in FIGS. 2 and 6, the handle part 20 may be configured such that a radius R1 of curvature on the front surface side S1 of the handle part 20 when the razor 1 is viewed from the side surface is larger than a radius R2 of curvature on the front surface side S1 of the handle part 20 when the razor 1 is viewed from the upper side U.

According to such a configuration, when the handle part 20 is gripped, the fingers placed on the front surface side S1 easily fit the handle part 20, and even in a case where the handle part 20 is elliptical, the orientation of the handle part 20 can be easily grasped by the feel of the fingers due to the difference in radius of curvature.

As illustrated in FIG. 2, when the razor 1 is placed on the predetermined plane P, there may be a gap S formed between a lower end 20E of the handle part 20 and the predetermined plane P.

According to such a configuration, the user can easily hold the razor 1 from a state where the razor 1 is placed on the predetermined plane P by inserting a finger into the gap S.

The user can hold the handle part 20 by placing the fingers on the handle part 20 from one side in the width direction of the handle part 20, placing three fingers, the index finger, the middle finger, and the ring finger, or placing four fingers even including the little finger on the front surface side S1, and placing the ball surface of the thumb on the back surface side S2.

As a result, the handle part 20 can be pinched by the fingers. By holding the handle part 20 in this manner, even if the angle of the fingers with respect to the handle part 20 is changed according to the use state of the razor 1, it is easy to operate the razor 1 and shave armpit hair. In addition, it is easy to use even for people with different hand sizes, from elementary school students to adults, and people who are not accustomed to using a razor.

The razor 1 according to the present embodiment makes it easy for the user to place the blade edge 11A of the blade body 11 of the razor 1 in the armpit recess.

When the user shaves armpit hair, the user may raise the arm firmly to make the armpit almost flat so that an armpit recess is not formed. However, keeping the arm raised for a long time may be tiring, causing a recess in the armpit. Therefore, according to the present embodiment, it is possible to provide the razor 1 that can easily shave armpit hair even in a state where a recess is formed.

The shaving of armpit hair is performed regardless of sex, and there are many people who want to shave armpit hair from early teens including elementary school students to adults. According to the present embodiment, it is possible to provide a razor enabling any person to easily shave armpit hair by itself regardless of age and sex.

Goal 10 of the SDGs includes “eliminate human or national inequalities”, and the razor 1 according to the present embodiment is a product related to that goal.

Although the present invention is explained in detail using the above-mentioned embodiments, it will be apparent to those skilled in the art that the present invention is not limited to the embodiments described herein. The present invention can be implemented as modifications and changes without departing from the spirit and scope of the present invention defined by the description of the claims. Accordingly, the description of the present specification is for the purpose of illustration and is not intended to limit the present invention in any way.

What is claimed is:

1. A razor having a vertical direction including an upper side and a lower side and a thickness direction including a front surface side and a back surface side, the razor comprising:
a head part to which a blade body is attached;
a handle part;
a placement surface that comes into contact with a predetermined plane when the razor is placed on the predetermined plane; and
a central surface passing along the placement surface and passing through a center of the handle part in the thickness direction, wherein
a blade edge of the blade body is directed toward the upper side from the central surface toward the placement surface, when the razor with the head part disposed on the upper side is viewed from a side surface thereof,
the blade body is curved so as to convex toward the upper side, when the razor with the head part disposed on the upper side is viewed from the back surface side, and
the back surface side is divided by a plurality of curved portions curved so as to be convex toward the upper side and a plurality of straight portions extending in the vertical direction.

2. The razor according to claim 1, further comprising a plurality of comb teeth members arranged at first intervals along an extending direction of the head part on the back surface side of the blade body when the razor is viewed from the upper side.

3. The razor according to claim 2, wherein
the comb teeth members are formed in an annular shape.

4. The razor according to claim 1, wherein
the head part includes a guard portion disposed so as to cover at least a part of the blade edge of the blade body.

5. The razor according to claim 1, wherein
the handle part has a shape that is convex on the front surface side and concave on the back surface side.

6. The razor according to claim 1, wherein
a radius of curvature of the handle part on the front surface side when the razor is viewed from the side surface is larger than a radius of curvature of the handle part on the front surface side when the razor is viewed from the upper side.

7. The razor according to claim 1, wherein
a gap is formed between a lower end of the handle part and the predetermined plane when the razor is placed on the predetermined plane.

8. The razor according to claim 2, wherein
the head part includes a guard portion disposed so as to cover the blade edge of the blade body at second intervals, and
the first intervals are larger than the second intervals.

9. The razor according to claim 6, wherein
the curved portions and the straight portions constitute an inverted U-shaped rib when the razor with the head part disposed on the upper side is viewed from the back surface side,
a plurality of the ribs are arranged at regular cycles in an extending direction of the head part,
a plurality of the ribs are arranged in the vertical direction, and
the regular cycles of the ribs adjacent in the vertical direction are shifted from each other by a half period.

10. The razor according to claim 1, wherein
the handle part has a width that increases as being farther away from the head part, and decreases after the center of the handle part in the vertical direction when the razor is viewed from the front surface side and when the razor is viewed from the back surface side.
